(19) United States
(12) Patent Application Publication
(10) Pub. No.: US 2026/0170104 A1
(43) Pub. Date: Jun. 18, 2026

(54) MULTI-SESSION AGENT AUTHENTICATION FOR ACCESSING DATA RECORDS

(71) Applicant: T-MOBILE INNOVATIONS LLC, Overland Park, KS (US)

(72) Inventors: Tanmaya GAUR, Kirkland, WA (US); Valeri Lane Reeves, Seattle, WA (US); Sri Lakshmi Narasimha Charan Teja Reminisetty, Bellevue, WA (US); Suman Bethi, Issaquah, WA (US)

(21) Appl. No.: 18/979,288

(22) Filed: Dec. 12, 2024

(51) Int. Cl. G06F 21/31

(52) U.S. Cl. CPC G06F 21/31

(57) ABSTRACT

In various embodiments, systems and methods for multi-session agent authentication for accessing data records are provided. In some embodiments, solutions are provided that address the problem of safeguarding user data records from unauthorized release. In some embodiments, an API-based solution establishes a multiple-principal, multiple-session database of session data. The agent session database may be hosted locally on the user equipment of the agent that hosts the one or more agent user interface applications. One or more agent user interface applications hosted on an agent’s UE may concurrently maintain access sessions for accessing multiple user data profiles based on managing token data using the database of agent session data and using session-related information to access a system of records. In some embodiments, session identification data stored in the agent session data may be leveraged to initiate session extensions and/or application handovers without having to revalidate a customer.

### BACKGROUND

Many modern customer care scenarios involve a customer service agent obtaining access to customer records in order to provide the requested assistance. Often, the customer service agent obtains the customer records by accessing those records from a database (e.g., a customer relationship management system). For example, a customer service agent may need to transact with data securely stored by the company in a user account profile. The customer service agent would first authenticate themselves, and the customer would then typically be expected to provide details that prove their identity to the customer service agent. The customer service agent may then gain access to the company’s system of records and the specific user data profile for the customer. Once a customer is verified, the context of interactions between the customer service agent and the system of records, including authentication and authorization of which customer was verified by which agent, is secured using security tokens that serve as proof of authentication to confirm that the customer service agent has successfully authenticated as an agent authorized to access the user data profile from the system of records.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

The present disclosure is directed, at least in part, to multi-session agent authentication for accessing data records, substantially as shown and/or described in connection with at least one of the Figures, and as set forth more completely in the claims. In some embodiments, solutions are provided that address the problem of safeguarding user data records from unauthorized release. In contrast to existing authentication frameworks for principal-agent related transactions, embodiments presented herein, among other things, provide an application programming interface (API)-based solution that establishes a multiple-principal, multiple-session data storage structure (e.g., a database) of agent session data. The agent session database may be hosted locally on the user equipment of the agent that hosts the one or more agent user interface applications. With one or more of the embodiments described herein, one or more agent user interface applications hosted on an agent’s user equipment (UE) may concurrently maintain access sessions for accessing multiple user data profiles based on managing token data using the database of agent session data and passing session, agent, and customer data to the system of records based on the agent session data. In some embodiments, session identification data stored in the agent session data may be leveraged to initiate session extensions and/or application handovers without having to revalidate a customer.

### BRIEF DESCRIPTION OF THE DRAWINGS

Aspects of the present disclosure are described in detail herein with reference to the attached Figures, which are intended to be exemplary and non-limiting, wherein:

FIGS. 1A and 1B are diagrams illustrating an example operating environment comprising a validation framework for multi-session agent authentication, in accordance with some embodiments;

FIGS. 2A-2D are data flow diagrams illustrating multi-session agent authentication, in accordance with some embodiments;

FIG. 3 is a diagram illustrating an example message exchange process for extending an active access session in accordance with some embodiments;

FIGS. 4A-4D are data flow diagrams illustrating a session handover process, in accordance with some embodiments;

FIG. 5 is a diagram illustrating an example telecommunications network environment comprising a network function for providing a validation framework as a network service, in accordance with some embodiments;

FIG. 6 is a flow chart illustrating an example method for multi-session agent authentication for accessing data records, according to some embodiments;

FIG. 7 is a flow chart illustrating an example method for multi-session agent authentication for accessing data records, according to some embodiments;

FIG. 8 is a diagram illustrating an example computing environment, in accordance with one embodiment; and

FIG. 9 is a diagram illustrating an example cloud computing environment, in accordance with some embodiments.

### DETAILED DESCRIPTION

Embodiments of the present disclosure provide for a token exchange and session-based mechanism that permits an agent (e.g., a customer service agent) to obtain and concurrently use credentials that provide access to database records for multiple principals (e.g., customers). That is, the present disclosure provides embodiments that, among other things, provide for authentication of a principal user and confirmation of the principal user’s consent when an agent acts on behalf of the principal user to access the principal user’s data, or to otherwise access services to act on behalf of the principal user. The token exchange and session-based mechanisms described herein permit the agent to dynamically switch between sessions to access different user data profiles (for different principal users), without having to re-obtain credentials each time they switch between sessions.

For a customer service agent (referred to herein more simply as an “agent”) to access a user data profile from a system of records (e.g., a customer relationship management (CRM) system), two primary verifications are typically involved: 1) a confirmation that the agent is verified (e.g., authenticated) as being someone authorized to access the system of records; and 2) a confirmation that the customer (referred to more generally herein as the “principal”) is verified as being the individual that they purport to be and associated with the user data profile (e.g., they are an owner of the account associated with the user data profile), and have an access level to authorize the agent to perform the tasks being requested. Identity providers (IDPs) are an example of a service that manages and authenticates user identities. IDPs handle the process of verifying who a user is and providing the necessary credentials for accessing various applications, data records, and services. When a user (e.g., a principal user or an agent user) authenticates themselves with an IDP, the IDP may issue a token (or a hash code convertible into a token) that provides the user with credentials (e.g., Open Authorization (OAuth) 2.0-based credentials) that the user may use to access one or more services and/or systems. These tokens may contain information about the user, such as but not limited to, an identification of the user, and may be used in OpenID Connect (OIDC) frameworks (e.g., Internet Engineering Task Force (IETF) Request for Comments (RFC) 6749 and 6750) to provide user profile information. Tokens obtained from authentication with an IDP are stored locally on the user’s device, for example as an application session cookie. The tokens may remain valid for a predetermined duration, for example, for the duration of a session between the application and the service being accessed, or other duration as determined by the application and/or IDP.

In the case of an agent obtaining access to a user data profile for the benefit of assisting a principal (e.g., a customer), there may often be a principal user IDP used by the principal user to authenticate their identity and obtain a principal identification (ID) token (referred to herein as a p-token), and an agent IDP used by the agent to authenticate their identity to obtain an agent ID token (referred to herein as an a-token). The agent may operate user equipment (e.g., a smart phone, tablet, or other computing device) executing an application (e.g., a website browser application or a native client application) that provides an agent user interface (AUI) through which the agent can access user profile data from the system of records, based at least in part on the issued p-token and a-token. For example, the AUI may issue calls to one or more application programming interfaces (APIs) in which the AUI passes the p-token and a-token (or a composite token derived from the combination of the p-token and a-token) to obtain a level of access or perform certain transactions with the user profile data.

However, an issue that arises with currently available IDP-based authentication frameworks is that they do not support the ability for an agent’s AUI to access multiple user data profiles at the same time to enable the agent to efficiently service and assist multiple principals concurrently (e.g., via multiple customer sessions) via the AUI. In some instances, token data utilized by the AUI may be stored in one or more cookies when a session with a server is created, and those cookies may be used across various operations of the AUI. Switching between multiple sessions while attempting to concurrently assist different principals may trigger purging and/or overwriting of cookies that store token data, resulting in the AUI having to reload, or otherwise re-obtain token credentials from IDPs each time a switch is made between principals – adding complexity, and extraneous overhead network traffic and resource consumption to the system used to provide customer support. A further challenge occurs in maintaining valid authorization credentials when an agent switches from an initial AUI application to another AUI application, for example, where an a-token is AUI application specific.

In contrast to existing authentication frameworks for principal-agent related transactions, embodiments presented herein, among other things, provide an API-based solution that establishes a multiple-principal, multiple-session data storage structure (e.g., a database) of agent session data. The agent session database may be hosted locally on the user equipment of the agent that hosts the one or more AUI applications (e.g., used for establishing customer support “access sessions” -- for accessing user profile data associated from the system of records). An API framework may be characterized as a set of APIs that provide backend services and data via API calls (e.g., selective access to user data profiles). A headless API comprises an API that may respond to API calls without being specifically tied to a particular frontend component (e.g., a specific AUI application). As discussed in further detail below, with the embodiments described herein, one or more AUIs hosted on an agent’s UE may concurrently maintain access sessions for accessing multiple user data profiles based on managing token data using a local database of agent session data and passing tokenized agent and customer data to the system of records based on the agent session data.

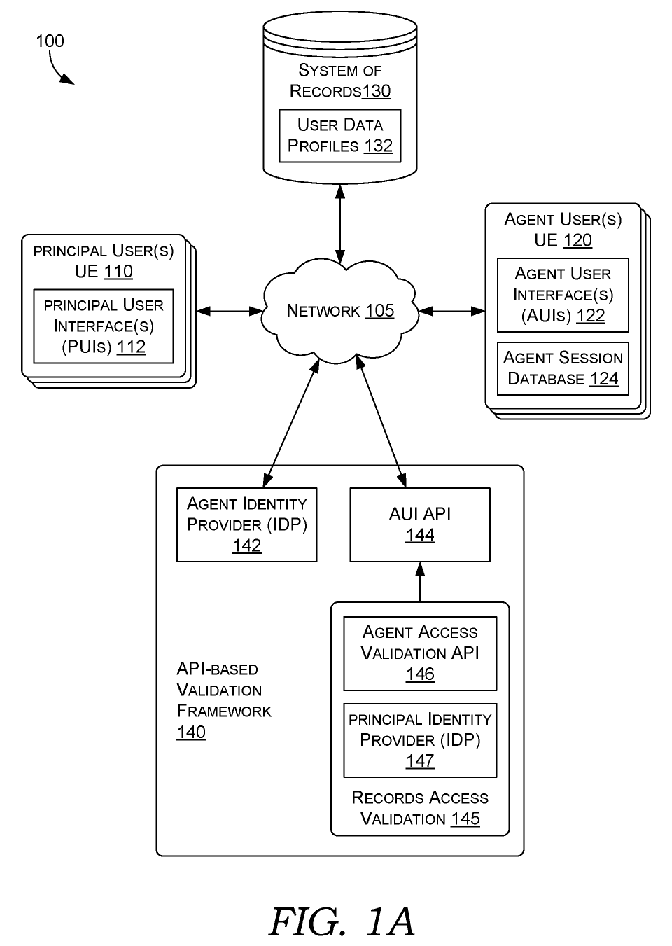

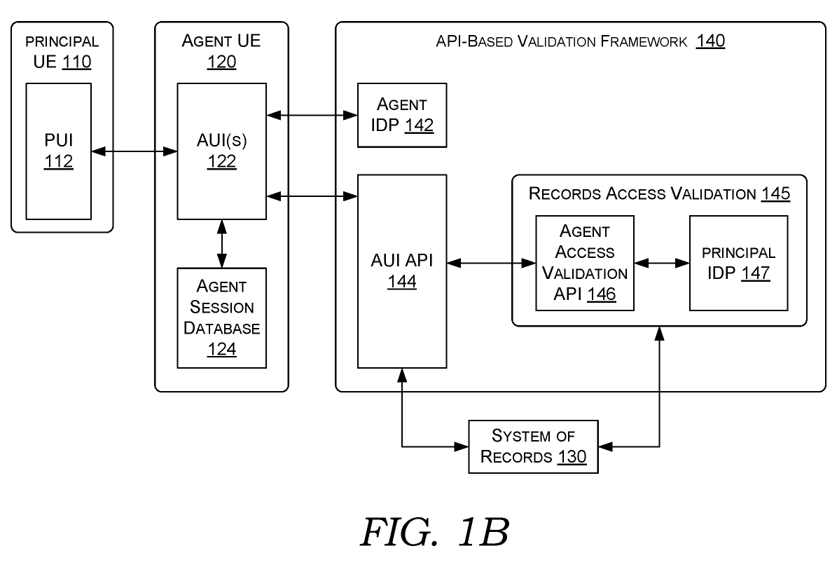

FIG. 1A is a diagram illustrating an example network operating environment 100, in accordance with some embodiments described herein. As shown in FIG. 1A, operating environment 100 comprises at least one principal user equipment (UE) 110 (e.g., one or more principal UEs 110), at least one agent UE 120, a system of records 130 storing user data profiles 132 (e.g., user data profiles associated with the principal users using the UE 110) and an API-based validation framework 140.

A principal user UE 110 and agent user UE 120 may comprise any form of computing device comprising such as, but not limited to, workstations, desktop computers, laptop computers, smart phones, tablets, handheld and/or wearable computing devices, personal digital assistants, a fitness tracker, or any other device capable of communicating using one or more resources of the network 105. The terms “user equipment,” “UE,” and/or “user device” are used interchangeably to refer to a device employed by an end user that communicates using a network, such as network 105. UE 110 and UE 120 may include components such as software and hardware, one or more processors (e.g., processing circuits), a memory, a display component, a power supply or power source, a speaker, a touch-input component, a keyboard, and the like. The processor may be programmed to execute code to implement one or more of the functions of the UE 110 and UE 120 described herein. More specifically, the UE 110 for a principal user may execute one or more software applications that implement a principal user interface (PUI) 112 that may be used by a principal user to interface with and/or perform transactions via network 105 with an agent user of a UE 120 for an agent user. A UE 120 for an agent user may execute one or more software applications that implement one or more agent user interfaces (AUIs) 120 that an agent may use to interface with and/or execute one or more transactions via network 105 with the principal user of a UE 110, and/or obtain access (e.g., via network 105) to one or more user data profiles 132 hosted by a system of records 130, as described in greater detail herein. Each of the principal user UE 110 and agent user UE 120 may comprise a wired or wireless network interface though which they communicate via the network 105. The at least one network 105 may include any form or combination of wired or wireless communication networks including, but not limited to, a cellular communications network (e.g., a 5G telecommunications network), one or more prior access technology networks (e.g., Long-Term Evolution (LTE)), and/or the Internet.

The system of records 130 may comprise a data store, database, server, and/or other computing platform that executes at least one service that provides access to user data profiles 132 associated with a principal user (e.g., customers, account owners, etc.). In some embodiments, the system of records 130 represents a customer relationship management (CRM) system. As the terms are used herein, a “data profile,” “user data,” “user data profile,” “user profile,” or “profile data” are used synonymously and may comprise an account, ledger, database, and/or other data having, for example, personal, financial, medical, educational, or other records and/or histories associated with a principal user. Access to the user data profiles 132 on a system of records 130 is secured such that the principal user does not directly interface with the system of records 130 or their respective user data profile 132. Instead, a user works through an agent operating an agent UE 120 in order to access, update, or otherwise execute one or more transactions that involve or use the data in the user data profile 132.

For one or more of the embodiments described herein, an agent uses one or more of the AUIs 122 to issue API calls to obtain access to the user data profiles 132. AUIs 122 may include applications hosted on a UE (e.g., a website browser or a native client application) that may be used to access information from a network server. As described herein, the authorization for the AUIs 122 to issue API calls to access the user data profiles 132 and/or services of the system of records 130 is managed at least in part by authentications and/or credentials obtained via the API-based validation framework 140 and/or using an agent session database 124 that locally stores credential data (e.g., tokens) and/or other metadata for one or more principal users and the respective access sessions associated with those principal users established between the AUIs 122 and the system of records 130. As further discussed herein, the API-based validation framework 140 may include a framework of validation services that include, but are not limited to, an agent identity provider (agent IDP) 142, an AUI API 144, and a records access validation function 145 that include an agent access validation API 146 and/or a principal identity provider (principal IDP) 147.

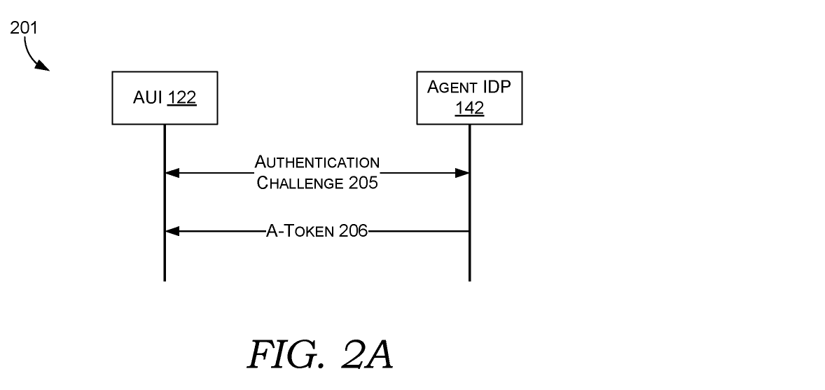

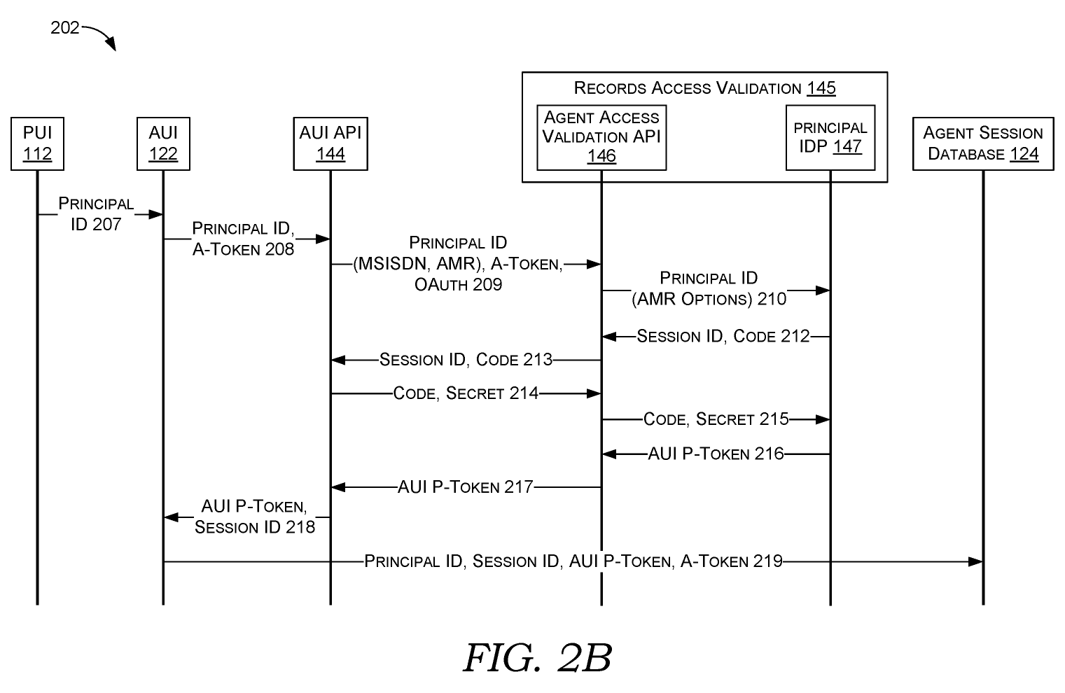

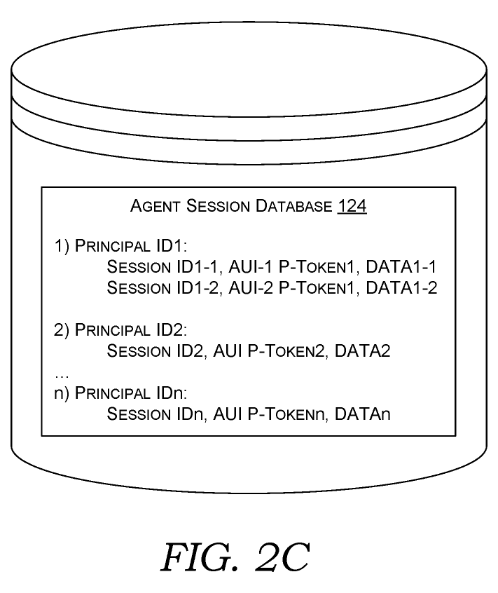

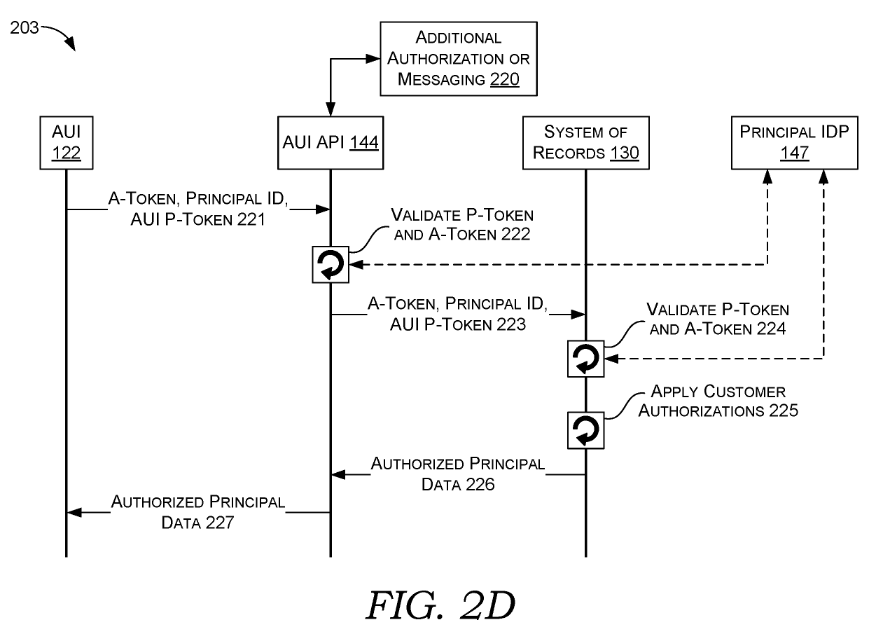

FIG. 1B is a diagram illustrating an example configuration between a PUI 112 in communication with an AUI 122, and transactions between the AUI 122 and elements of the API-based validation framework 140 that provide credentials for the AUI 122 to obtain access to the system of records 130. The data flow in FIG. 1B may be described more particularly with respect to the example data flow diagrams illustrated in FIGS. 2A-2D.

As shown starting with FIG. 2A at 201, for an agent to be able to assist a principal, the agent may first authenticate themselves using an agent IDP 142 to obtain an agent token, referred to herein as an a-token. The agent proceeds through an authentication challenge 205 with the agent IDP 142, which may include, for example, a user identification and passcode challenge, a secret key exchange, a response to a push code presented on the UE 120, and/or other authentication handshake processes. In response to successfully completing the authentication challenge 205, the AUI 122 receives an a-token 206 from the agent IDP 142, which the agent may then proceed to use to authenticate themselves to other network services.

With reference next to FIG. 2B generally at 202, for the agent to commence assisting the principal user, the PUI 112 of the principal user’s UE 110 may communicate to the AUI 122 a principal ID (shown at 207). The principal ID 207 may include a combination of data that uniquely specifies the identity of the principal user for which the AUI 122 will attempt to access the system of records 130. For example, the principal ID may include, as non-limiting telecommunication scenario examples, an Authentication Methods Reference (AMR), a Mobile Station International Subscriber Directory Number (MSISDN), a personal identification number (PIN), and/or another identifier such as an identifier tied to a billing account number (BAN).

With the agent authenticated, the AUI 122 has the a-token and may proceed to request a p-token that will be used by the AUI 122 to establish an access session to access the system of records 130, and establish a session ID for that session. This part of the process commences with the AUI 122 communicating the principal ID (e.g., principal user credentials) and the agent’s a-token to the AUI API 122 as shown at 208. In some embodiments, the a-token may be issued for use with a respective application on UE 120 that provides the AUI 122 and indicates an identity of that application. The AUI API 144 may proceed to obtain a p-token by initiating a request message 209 to the records access validation 145, wherein the request message 209 includes the principal ID, the a-token, and OAuth credentials derived using the a-token. The request message 209 may be received at the agent access validation API 146, and proceed to validate the a-token. If the agent access validation API 146 validates the a-token, the agent access validation API 146 may provide the principal ID to the principal IDP 147 as a credential for the principal user as shown at 210. In some embodiments, when the principal ID comprises an AMR, the AMR and one or more AMR options may be provided to the principal IDP 147 as a credential for the principal user. The principal IDP 147 may perform one or more verifications to check that the provided principal ID is valid (e.g., based on confirming the principal ID against a database of valid principal IDs). When the principal ID is confirmed as valid, the principal IDP 147 establishes an access session that is assigned to the principal user. As shown at 212, the principal IDP 147 may then return a session ID and a code to agent access validation API 146, where the code may be used to generate the p-token. The code is issued specific to the principal user and tied to that user, and may include one or more security mechanisms. For example, in some embodiments the code may be encoded with an identity of the agent that initiated the request message 209. In some embodiments, the p-token may indicate the scope of access to the system of records 130 that the AUI 122 will be granted access to (e.g., which profiles and/or which fields of a user data profile 132 may be accessed).

The session ID and code may then be forwarded to the AUI API 144 (at 213) so that the AUI API 144 may return the code together with a secret on the AUI API 144 (e.g., a secret key or password) to the agent access validation API 146 (at 214). The agent access validation API 146 sends that information to the principal IDP 147 (at 215). The principal IDP 147 receiving the code and secret may convert the information into an AUI p-token, which comprises a p-token specific to the AUI 122 that may be used when accessing the system of records 130. The principal IDP 147 provides the AUI p-token to the agent access validation API 146 (at 216), which provides the AUI p-token to the AUI API 144 (at 217). The AUI API 144 may then provide the AUI p-token to the AUI 122 (at 218) that has now been authorized to use the p-token.

As shown in FIG. 2B at 219, once the AUI 122 has received the session ID and the AUI p-token has been granted and received, the AUI 122 may record an entry (e.g., a record) to the agent session database 124 using the session ID to provide a local reference of active access sessions that the agent has established and which may be used to access the system of records 130. Along with the session ID for each active access session, the agent session database 124 may include additional data regarding each session, such as, but not limited to, the principal ID and AUI p-token associated with each session, and may record the agent’s a-token (e.g., for use by an AUI).

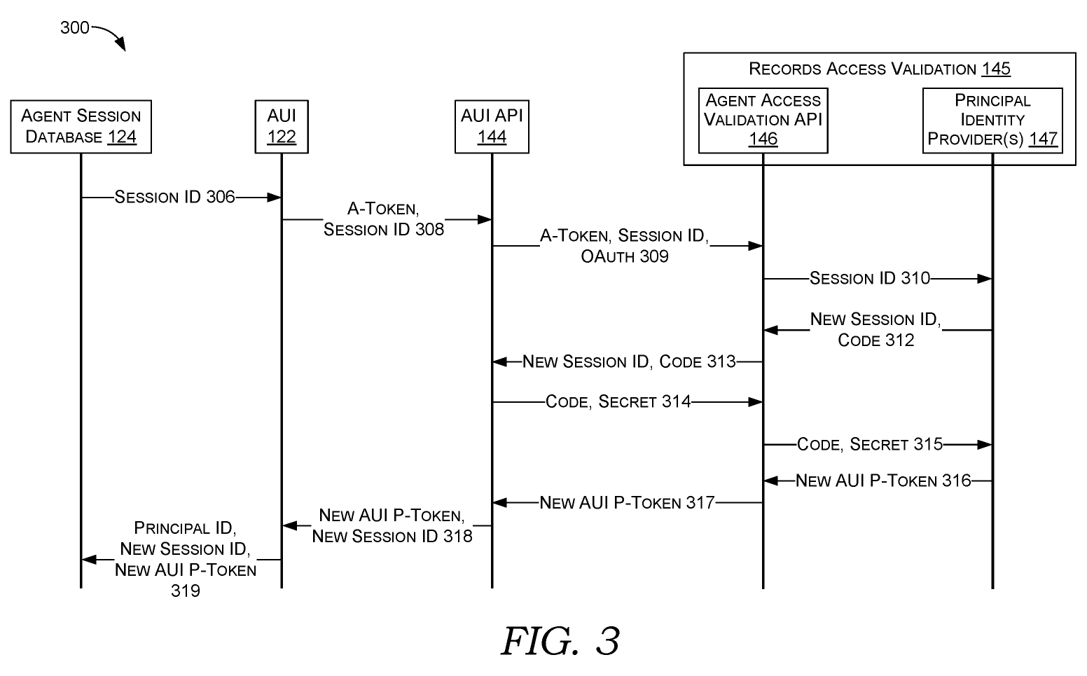

FIG. 2C illustrates a non-limiting example data structure for an agent session database 124. As discussed herein, the agent session database 124 provides a client-side database (e.g., hosted locally on the agent’s UE 120) where session data for a plurality of distinct sessions may be stored. Using the agent session database 124 may be either opposed to, or in addition to, the AUI 122 storing at least some session data as session cookies. As indicated in FIG. 2C, the session data may include session data associated with multiple different principal IDs. Having session data stored in the agent session database 124 (rather than as cookies) permits an AUI 122 to readily switch between previously established access sessions with the system of records 130 by obtaining the pertinent session ID and/or tokens directly from the agent session database 124 and using that information to continue performing transactions with the system of records 130. Moreover, as described below with respect to FIG. 3, the session data for an active access session may be used by an AUI 122 to request the principal IDP 147 to provide credentials for an extended session (e.g., to refresh a session) based on a session ID without having to re-authenticate the agent or re-validate the principal ID. Furthermore, for a given principal ID, the agent session database 124 may store data for one or more distinct session IDs – for example where a first AUI hosted on UE 120 is accessing data from the system of records 130 within a first access session, and where a second AUI hosted on UE 120 is accessing data from the system of records 130 within a second access session. Any of the AUIs hosted on a UE 120 may obtain the session data for any of the sessions established for that AUI (which may be associated with any one of one or more distinct principal IDs) based on referencing a corresponding session ID record in the agent session database 124.

Referring next to FIG. 2D at 203, this figure illustrates an example of a process by which an AUI 122 may proceed to access a user data profile 132 from the system of records 130.

To initiate access to a user data profile 132, the AUI 122 may issue a data request API call 221 to the AUI API 144. The data request API call 221 may include the a-token, the AUI p-token, and the principal ID. At 222, the AUI API 144 may validate the a-token and the AUI p-token. In some embodiments, validation may include the AUI API 144 performing one or more additional authorizations (shown at 220) based on logic and/or rules applicable to a particular AUI 122. In some embodiments, the AUI p-token may be validated through a call to the principal IDP 147.

When the AUI API 144 validates the a-token and/or the AUI p-token, the AUI API 144 may forward the a-token, the AUI p-token, and the principal ID to the system of records 130 (at 223), and the system of records 130 may itself validate the a-token and/or the AUI p-token (at 224). That is, instead of just relying on a valid authentication of the agent (via the a-token), the system of records 130 receives the combination of both the a-token of the agent and the p-token that was issued to the AUI 122 to validate the principal ID. The p-token may also serve to limit the agent’s access to the specific user data profile 132 corresponding to that principal ID. In some embodiments, the AUI p-token may be validated through a call to the principal IDP 147.

In some embodiments, when the system of records 130 validates the a-token and the AUI p-token, it may proceed to apply one or more principal authorizations (at 225) that define which user data profile 132 and/or what fields and/or records from a user data profile 132 the AUI p-token indicates are authorized to be provided as principal data back to the AUI 122. As shown at 226, the system of records 130 may transmit the authorized principal data to the AUI API 144, which in turn (at 227) transmits the authorized principal data to the AUI API 144 authorized to receive that data. The agent may then control and/or interface with AUI 122 (e.g., via a display screen of the UE 120) to perform one or more operations based on the authorized principal data, such as to display, modify and/or otherwise perform transactions with and/or based on the user data profile 132.

FIG. 3 is a diagram illustrating an example message exchange process 300 for extending (or renewing) an active access session. For example, in some implementations an AUI p-token issued by the principal IDP 147 may have a configurable finite lifetime after which the token expires and is no longer valid (e.g., 20 minutes, 30 minutes, etc.). As such, if an agent has been using AUI 122 over an active access session to assist a principal user for longer than the lifetime for which the token was issued, the AUI 122 will need to extend the access session by obtaining a refreshed AUI p-token. In some embodiments, the AUI 122 may determine from the agent sessions database 124 an indication of lifetime that indicates whether an AUI p-token associated with an access session is still live or expired, and if still alive, how much time the token has before expiring. For example, the AUI 122 may reference the agent sessions database 124 to determine the status of an AUI p-token for an access session (e.g., by referencing records based on a principal ID associated with the session). Similarly, in some embodiments when an AUI 122 is accessing a first user data profile 132 for one principal ID (to assist a first principal user) and needs to switch over to a second user data profile 132 for another principal ID (to assist a second principal user), the AUI 122 may reference the agent session database 124 to confirm whether the AUI p-token for the second principal user is valid or stale before making API calls to access the second user data profile 132.

When the AUI 122 determines that the AUI p-token is not stale (e.g., not expired and/or has a remaining lifetime greater than a threshold), then the AUI 122 may proceed to use the AUI p-token for accessing the system of records 130 (e.g., as illustrated by the example of FIG. 2D). When the AUI 122 determines that the AUI p-token is stale (e.g., that the token is either expired and/or that the token has a remaining lifetime then than a threshold), then the AUI 122 may proceed to refresh the AUI p-token such as by the example process 300 illustrated in FIG. 3. More specifically, the AUI 122 may use the stored session ID along with the a-token to extend the access session so that the AUI 122 may continue to access the user data profile 132 from the system of records 130.

As shown in FIG. 3, the AUI 122 may read from the agent session database 124 the current session ID for the access session that needs to be extended (at 306) and generate a request call 308 to the AUI API 144 that includes the session ID and the a-token. The AUI API 144 may then generate an access session extension request message 309 to the records access validation 145 function to obtain a new AUI p-token. The access session extension request message 309 may include the session ID of the access session to be extended, the agent’s a-token, and the OAuth credentials derived by the AUI API 144 using the a-token. The agent access validation API 146 may validate the a-token. If the a-token validates, the session ID may be provided to the principal IDP 147 as a credential for the principal user, as shown at 310. The principal IDP 147, having been the authority that previously issued the session ID and the now stale AUI p-token, may perform one or more verifications to check that the principal ID previously used as the credential remains valid (e.g., based on confirming the principal ID against a database of valid principal IDs).

When the principal ID is confirmed as still valid, the principal IDP 147 generates a new session ID to extend the access session for use by the AUI 122. As shown at 312, the principal IDP 147 may send, to the agent access validation API 146, a new session ID and code that may be used to generate a new (refreshed) p-token. The new session ID and code may then be forwarded to the AUI API 144 (shown at 313) so that the AUI API 144 may return the code together with a secret (e.g., a secret key or password) to the agent access validation API 146 (shown at 314). The agent access validation API 146 proceeds to send that information to the principal IDP 147 (shown at 315). The principal IDP 147 receiving the code and secret may convert the information into a new AUI p-token, which comprises a p-token specific to the AUI 122. The AUI 122 may use that new token to continue its access session with the system of records 130. The principal IDP 147 provides the new AUI p-token to the agent access validation API 146 (at 316), which provides the new AUI p-token to the AUI API 144 (at 317), which in turn provides the new AUI p-token to the AUI 122 (at 318) that has now been authorized to use the new p-token. As shown at 319, once the AUI 122 has received the new session ID and the new AUI p-token, the AUI 122 may update the agent session database 124, for example with a new session ID and AUI p-token, as discussed above.

In some use cases, an agent UE 120 may host a suite of individual AUIs where each AUI is focused on performing a set of tasks, and an agent may need to switch between two or more different AUIs in the course of assisting a principal user. As non-limiting examples, a first AUI may be directed to billing-related tasks, a second AUI may be directed to customer subscription updates, a third AUI may be directed to retail purchases, and a fourth AUI may be directed to assisting a principal with troubleshooting problems with their product or service.

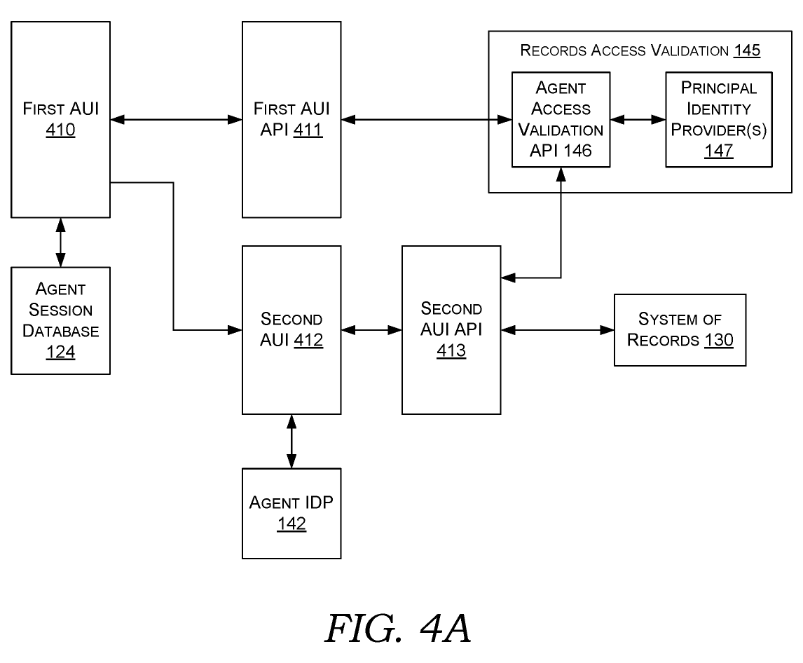

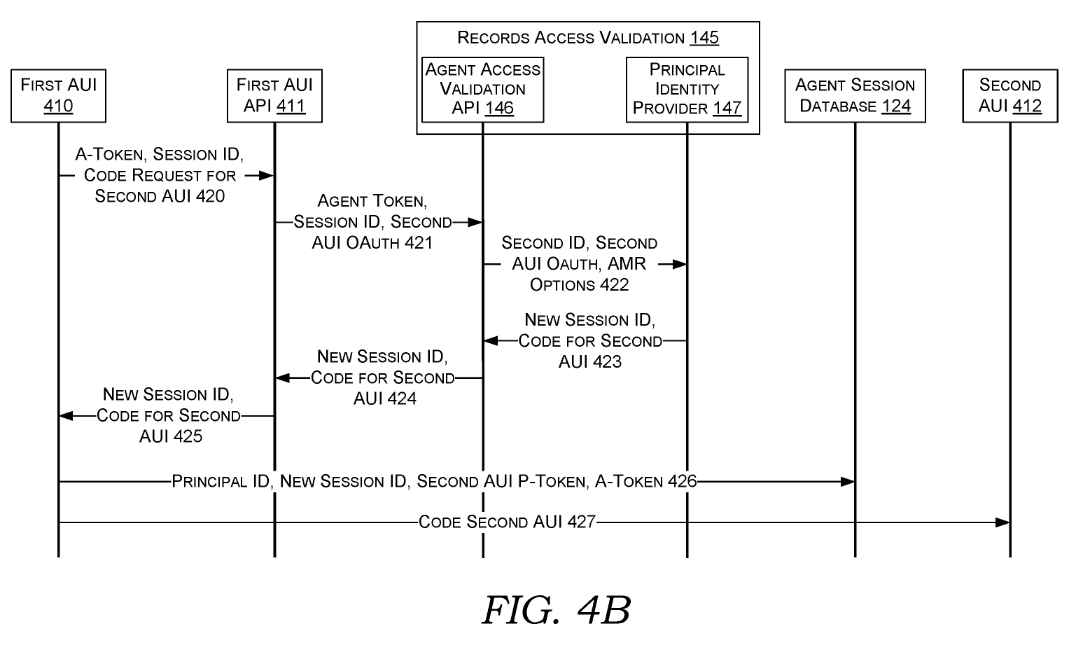

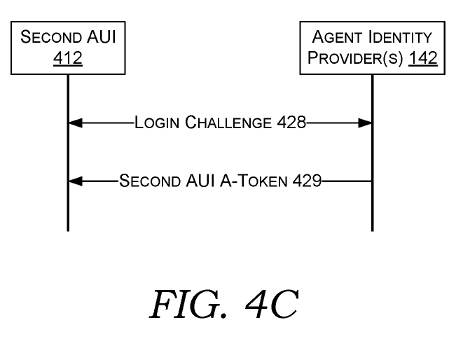

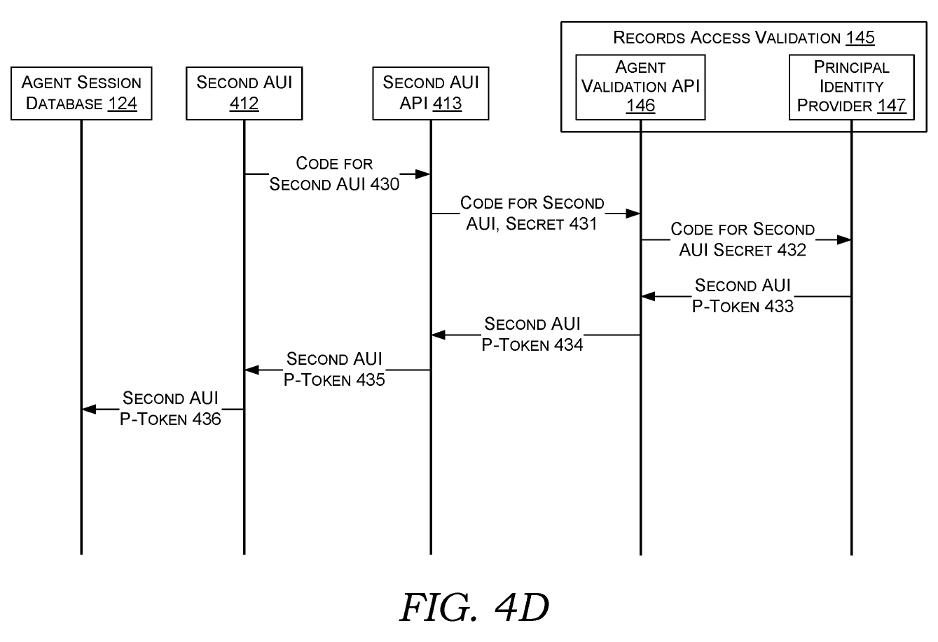

As illustrated in FIGS. 4A-4D, a session ID initially obtain by a first AUI from a principal IDP 147 (and stored to the agent session database 124) may be utilized to facilitate a session handover request to hand over the access session to a second AUI without having to re-verify the principal ID as the agent moves between AUIs and their associated access sessions with the system of records 130.

Referring to FIG. 4A, a first AUI 410 may initialize an access session by obtaining a session ID and an AUI p-token from the record access validation function 145 in the manner described above for AUI 122, and the agent session database 124 updated with a first session ID, a first AUI p-token, a principal ID, and/or other session data as discussed herein. In this example, the agent may need to switch from the first AUI 410 to a second AUI 412 (where both AUI 410 and AUI 412 are hosted on the agent’s UE 120) to access and/or transact with a difference set of data from the system of records 130. In this example, the first AUI 410 may take the lead role in the handover process by communicating with the principal IDP 147 to obtain a new session ID and token generation code for the second AUI 412. The second AUI 412 may then call on its corresponding second AUI API 413 to use the new session ID and token generation code to obtain a new AUI p-token that the second AUI 430 may use to establish a new access session with the system of records 130.

As shown in FIG. 4B, the first AUI 410 may initiate the process by sending a code request 420 to the first AUI API 411 that includes the agent’s a-token and the session ID associated with AUI 410’s current active access session. The first AUI API 144 may generate a request message 421 to the records access validation 145 function to obtain a code for an AUI p-token that it may provide to the second AUI 412. The request message 421 may include the current session ID, the agent’s a-token, and in some embodiments, OAuth credentials for the second AUI 412 derived using the a-token. In some embodiments, as shown in FIG. 2C, the agent may separately obtain OAuth credentials for the second AUI 412 from the agent IDP 142. In this example, the agent (vie the UE 120) proceeds through an authentication challenge 428, which may include, for example, a user identification and passcode challenge, a secret key exchange, a response to a push code presented on the UE 120, and/or other authentication handshake processes. In response to a successful authentication challenge 428, the second AUI 122 receives an updated a-token 429 from the agent IDP 142 that may provide the OAuth credentials for the second AUI 412. The request message 421 may be received at the agent access validation API 146 which may validate the a-token. If the a-token validates, the session ID and second AUI OAuth credentials may be provided by the agent access validation API 146 to the principal IDP 147 as a credential for the principal user as shown at 422. In some embodiments, one or more AMR options may be provided to the principal IDP 147.

The principal IDP 147 may perform one or more verifications to check that the session ID is still active and valid. When the session ID is confirmed as valid, the principal IDP 147 establishes a new access session assigned to the principal user for use by the second AUI 412. As shown at 423, the principal IDP 147 may then return to the agent access validation API 146 a new session ID and the code that may be used by the second AUI 412 to generate the AUI p-token it will use for its access session with the system of records 130. The code is issued specific to the principal and tied to that user and may include one or more security mechanisms. For example, in some embodiments the code may be encoded with an identity of the agent that initiated the request message 421. In some embodiments, the p-token may indicate the scope of access to the system of records 130 that the second AUI 412 will be granted access to (e.g., specifying which user data profiles and/or specifying which field of a user data profile may be accessed).

The new session ID and code may be returned to the first AUI API 411 (shown at 424), which forwards the new session ID and code 425 to the first AUI 410. The first AUI 410 may update the agent session database 124 (shown at 426) to include a record of the new session ID associated with the principal ID and for use by the second AUI 412, and forward the code to the second AUI 412 (shown at 427) to enable the second AUI 412 to obtain its own AUI p-token as illustrated in FIG. 4D.

Referring next to FIG. 4D, the second AUI 412 sends the code to the second AUI API 413 as shown at 430. The second AUI API 413 returns the code together with a secret (e.g., a secret key or password) to the agent access validation API 146 (at 431), which sends that information to the principal IDP 147 (at 432). The principal IDP 147 receives the code and secret and converts the information into an AUI p-token, which comprises a p-token specific to the second AUI 412. The principal IDP 147 provides the AUI p-token to the agent access validation API 146 (at 433), which provides the AUI p-token to the second AUI API 413 (at 434). The second AUI API 413 then may provide the AUI p-token to the second AUI 412 (at 435) so that the second AUI 412 is now authorized to use the p-token to access the system of records 130. In some embodiments, the second AUI 412 may record the AUI p-token to the agent session database 124 (at 436) based on the second session ID assigned to the second AUI 412.

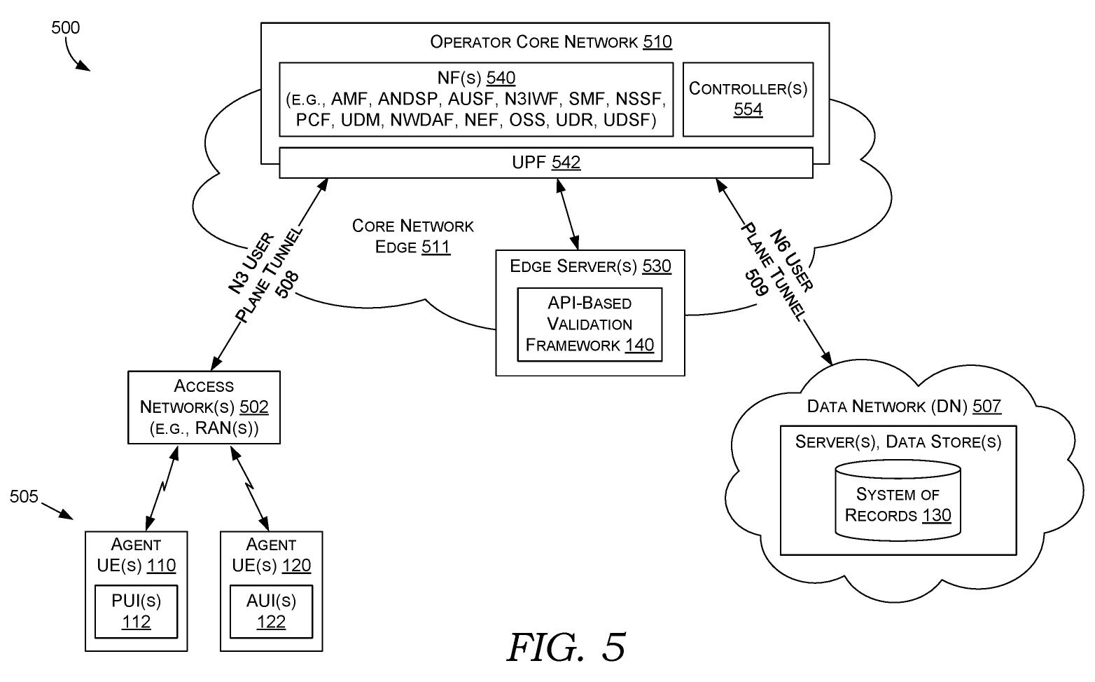

Referring now to FIG. 5, FIG. 5 is a diagram illustrating an example telecommunications network environment comprising a network function for providing a validation framework 140 (e.g., an API validation framework) as a network service. FIG. 5 illustrates an example embodiment where the functions of an API-based validation framework 140 may be provided as a network service by at least one network function of a telecommunications network 500. For example, the at least one network function may respond to API calls from an agent UE 120 to establish and instantiate tokens, session IDs, and/or access sessions that permit one or more AUIs on the agent UE 120 to access user data (associated with a principal user) from the system of records 130.

More specifically, FIG. 5 is a diagram illustrating an example network environment 500 embodiment for a wireless communication system 500 that provides multi-session agent authentication for accessing data records. Network environment 500 is but one example of a suitable telecommunications network and is not intended to suggest any limitation as to the scope of use or functionality of the embodiments disclosed herein, and nor should the network environment be interpreted as having any dependency or requirement relating to any one or combination of components illustrated.

As shown in FIG. 5, network environment 500 comprises an operator core network 510 (also referred to as a “core network”) that provides one or more network services to one or more UEs 505 (which may include one or more principal UE(s) 110 and/or one or more agent UE(s) 120) via at least one access network 502, which may comprise a radio access network (RAN). In some embodiments, network environment 500 comprises, at least in part, a wireless communications network, such as, but not limited to, a 5G wireless communications network. In some embodiments, the access network(s) 502 of network environment 500 comprises one or more RANs, which may be referred to in the context of a wireless telecommunications network as a wireless base station, cell site, or cellular base station. At least one RAN may represent at least one wireless base station coupled to the operator core network 510 to establish one or more communication links between the operator core network 510 and UE 505. Each RAN may provide wireless connectivity access to one or more UEs 505 operating within one or more coverage areas associated with a particular RAN. The RAN may implement wireless connectivity using, for example, 3rd Generation Partnership Project (3GPP) technologies. The one or more of the access network(s) 502 may be referred to as an eNodeB in the context of a 4G Long-Term Evolution (LTE) implementation, a gNodeB in the context of a 5G New Radio (NR) implementation, or other terminology depending on the specific implementation technology. In some embodiments, access networks 502 may comprise, at least in part, components of a customer premises network, such as a distributed antenna system (DAS), for example. When an access network 502 is implemented as a RAN, the RAN may comprise a multimodal network (for example, comprising one or more multimodal access devices) where multiple radios supporting different systems are integrated into the RAN. Such a multimodal access network may support a combination of 3GPP radio technologies (e.g., 4G, 5G, and/or 6G) and/or non-3GPP radio technologies (e.g., Institute of Electrical and Electronics Engineers (IEEE) 802.11 (WiFi) and/or IEEE 802.15 (Bluetooth) access points). In some embodiments, access network(s) 502 may comprise a terrestrial wireless communications base station and/or may be at least in part implemented as a space-based access network, such as a base station implemented by an Earth-orbiting satellite. Individual UE 505 may communicate with the operator core network 510 via the access network(s) 502 over one or both of uplink (UL) radio frequency (RF) signals and downlink (DL) radio frequency (RF) signals.

As shown in FIG. 5, access networks 502 may be coupled to the operator core network 510 via a core network edge 511 that comprises edge server nodes and wired and/or wireless network connections that may further include wireless relays and/or repeaters. In some embodiments, the access networks 502 may be coupled to the operator core network 510 at least in part by a backhaul network such as the Internet or other public or private network infrastructure. Core network edge 511 may comprise one or more network nodes (e.g., servers) or other elements of the operator core network 510 that may define the boundary of the operator core network 510 and may serve as the architectural demarcation point where the operator core network 510 connects to other networks such as, but not limited to, access networks 502, the Internet, a Data Network (DN) 507, and/or other third-party networks. In some embodiments, the network edge 511 may comprise one or more network nodes that include at least one edge server 530. One or more edge server(s) 530 may provide, for example, edge-based network function services to UEs 505 that may be accessed separately from services provided by network functions of the operator core network 510. For example, edge server(s) 530 may host databases, caches, microservices, ledgers, decentralized applications (e.g., DApps), and/or may perform data traffic monitoring, inspections, and/or aggregation for other network functions of the network environment 500. As illustrated in FIG. 5, one or more functions of the API-based validation framework 140 described herein may be implemented as code executed by one or more processors (comprising processing circuitry) of one or more of the edge server(s) 530.

It should be understood that in some aspects, the network environment 500 may not comprise a distinct operator core network 510, but rather may implement one or more features of the operator core network 510 within other portions of the network, or may not implement them at all, depending on various carrier preferences.

As shown in FIG. 5, network environment 500 may also comprise at least one data network (DN) 507 coupled to the operator core network 510 (e.g., via the network edge 511). DN 507 may include one or more data stores and/or one or more cloud-based servers such that UE 505 may access services and/or content provided by the data store(s) and/or server(s) of DN 507. For example, in some embodiments, the DN 507 may comprise one or more servers that host the system of records 130.

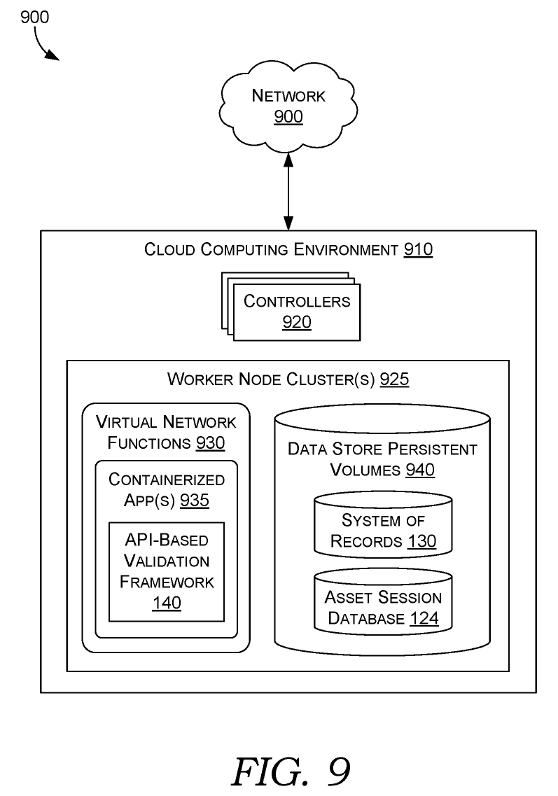

In some implementations, the operator core network 510 may comprise modules, also referred to as network functions (NFs), implemented by one or more processors and generally represented in FIG. 5 as NF(s) 540. Such network functions 540 may include one or more of, but not limited to, a core access and mobility management function (AMF), an access network discovery and selection policy (ANDSP), an authentication server function (AUSF), a user plane function (UPF), non-3GPP interworking function (N3IWF), a session management function (SMF), a network slice selection function (NSSF), a policy control function (PCF), a unified data management (UDM) function, a unified data repository (UDR), an unstructured data storage function (UDSF), a network data analytics function (NWDAF), a network exposure function (NEF), an operations support system (OSS), and/or other network functions. Implementation of these NFs 540 of the operator core network 510 may be executed by one or more controllers 554 on which these network functions are orchestrated or otherwise configured to execute utilizing processors and memory of the one or more controllers 554. The NFs may be implemented as physical and/or virtual network functions, container network functions, and/or cloud-native network functions, such as is described with respect to FIG. 9.

The user plane function (UPF), illustrated in FIG. 5 at 542, represents at least one function of the operator core network 510 that may extend into the core network edge 511. In some embodiments, the access network 502 is coupled to the UPF 542 within the core network edge 511 by a communication link that includes an N3 user plane tunnel 508. For example, the N3 user plane tunnel 508 may connect a cell site router of the access network 502 to an N3 interface of the UPF 542. The data store(s), server(s), and/or other elements of DN 507 (including, for example, the system of records 130) may be coupled to the UPF 542 in the core network edge 511 by an N6 user plane tunnel 509. For example, the N6 user plane tunnel 509 may connect a network interface (e.g., a switch, router, and/or gateway) of the DN 507 to an N6 interface of the UPF 542. In some embodiments, the operator core network 510 may comprise a plurality of UPFs 542, such as a UPF at the operator core network 510 and a UPF at the core network edge 511. For example, a UPF at the core network edge 511 may be used for local breakout and/or low-latency types of applications via an N9 interface between the distinct UPFs.

In some embodiments, one or more aspects of a validation framework 140 may be implemented using one or more of the network functions 540 and provided to UE 505 as a network service offered from the operator core network 510 and/or edge server 530. In some embodiments, the agent session database 124 may be implemented at least in part as a server-side service hosted, for example, by edge server(s) 530. In some embodiments, the PCF of the operator core network 510 maintains subscription information indicating one or more services and/or microservices subscribed to by each UE 505, including the API exposed services of the validation framework 140. In operation, a validation framework 140 provided as a network function service of the operator core network 510 and/or edge server 530 may operate in the same manner as any of the validation frameworks described herein.

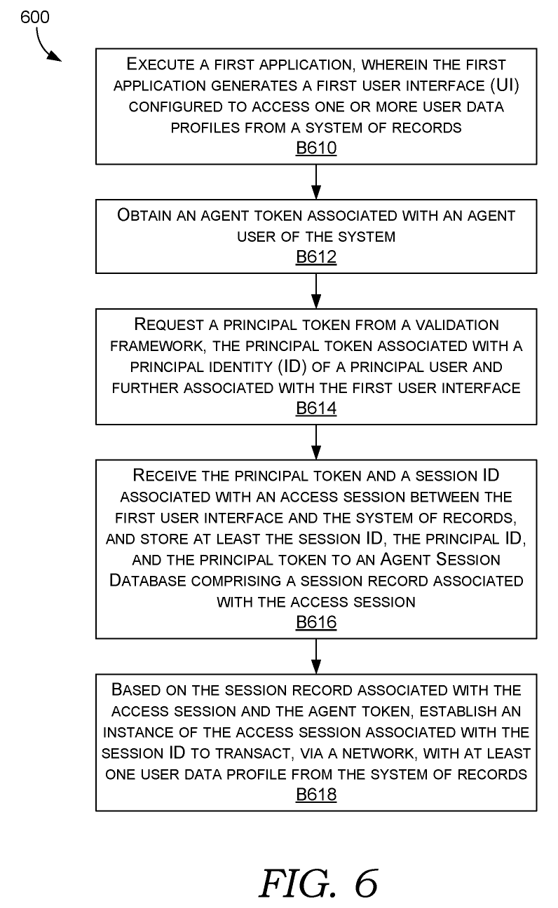

FIG. 6 is a flow chart illustrating a method 600 for multi-session agent authentication for accessing data records, according to some embodiments. It should be understood that the features and elements described herein with respect to the method of FIG. 6 may be used in conjunction with, in combination with, or substituted for elements of any of the other embodiments discussed herein and vice versa. Further, it should be understood that the functions, structures, and other descriptions of elements for embodiments described in FIG. 6 may apply to like or similarly named or described elements across any of the figures and/or embodiments described herein and vice versa. In some embodiments, elements of method 600 are implemented utilizing one or more processing units comprising processing circuitry, such as the controller of an operator core network, a network node, a networked server, an edge server, an access network, a RAN, user equipment (UE), a computing device, a cloud computing environment, and/or other processing units or computing devices as disclosed in any of the embodiments herein. In some embodiments, the method 600 may be implemented by components of a telecommunications network environment 500, such as illustrated by FIG. 5.

The method 600, at B610, includes executing a first application, wherein the first application generates a first user interface (UI) configured to access one or more user data profiles from a system of records. As explained herein, an agent user of a UE 120 may use one or more of the AUIs 122 to issue API calls to obtain access to the user data profiles 132. AUIs 122 may include applications hosted on a UE (e.g., a website browser or a native client application) that may be used to access information from a network server.

The method 600, at B612, includes obtaining an agent token associated with an agent user of the system. As discussed with respect to FIG. 2A, for an agent to be able to assist a principal, the agent may first authenticate themselves using an agent IDP 142 to obtain an agent token, referred to herein as an a-token. The agent proceeds through an authentication challenge 205 with the agent IDP 142, which may include, for example, a user identification and passcode challenge, a secret key exchange, a response to a push code presented on the UE 120, and/or other authentication handshake processes. In response to successfully completing the authentication challenge 205, the AUI 122 receives an a-token 206 from the agent IDP 142, which the agent may then proceed to use to authenticate themselves to other network services. With the agent authenticated, the AUI 122 has the a-token and may proceed to request a p-token that will be used by the AUI 122 to establish an access session to access the system of records 130, and establish a session ID for that session. This part of the process commences with the AUI 122 communicating the principal ID (e.g., principal user credentials) and the agent’s a-token to the AUI API 122. In some embodiments, the a-token may be issued for use with a respective application on UE 120 that provides the AUI 122 and indicates an identity of that application. The AUI API 144 may proceed to obtain a p-token by initiating a request message 209 to the records access validation 145, wherein the request message 209 includes the principal ID, the a-token, and OAuth credentials derived using the a-token.

The method 600 at B614 includes requesting a principal token from a validation framework, the principal token associated with a principal identity (ID) of a principal user and further associated with the first user interface. As previously discussed, the authorization for the AUIs 122 to issue API calls to access the user data profiles 132 and/or services of the system of records 130 is managed at least in part by authentications and/or credentials obtained via the API-based validation framework 140 and/or using an agent session database 124 that locally stores credential data (e.g., tokens) and/or other metadata for one or more principal users and the respective access sessions associated with those principal users established between the AUIs 122 and the system of records 130. As further discussed herein, the API-based validation framework 140 may include a framework of validation services that include, but are not limited to, an agent identity provider (agent IDP) 142, an AUI API 144, and a records access validation function 145 that include an agent access validation API 146 and/or a principal identity provider (principal IDP) 147. The request message 209 may be received at the agent access validation API 146, and may proceed to validate the a-token. If the agent access validation API 146 validates the a-token, the agent access validation API 146 may provide the principal ID to the principal IDP 147 as a credential for the principal user. In some embodiments, when the principal ID comprises an AMR, the AMR and one or more AMR options may be provided to the principal IDP 147 as a credential for the principal user. The principal IDP 147 may perform one or more verifications to check that the provided principal ID is valid (e.g., based on confirming the principal ID against a database of valid principal IDs). When the principal ID is confirmed as valid, the principal IDP 147 establishes an access session that is assigned to the principal user. The principal IDP 147 may then return a session ID and a code to agent access validation API 146, where the code may be used to generate the p-token.

The method 600 at B616 includes receiving the principal token and a session ID associated with an access session between the first user interface and the system of records, and stores at least the session ID, the principal ID, and the principal token to an agent session database comprising a session record associated with the access session. A session ID and code may be forwarded to the AUI API 144 so that the AUI API 144 may return the code together with a secret (e.g., a secret key or password) to the agent access validation API 146. The agent access validation API 146 sends that information to the principal IDP 147. The principal IDP 147 receiving the code and secret may convert the information into an AUI p-token, which comprises a p-token specific to the AUI 122 that may be used when accessing the system of records 130. The principal IDP 147 provides the AUI p-token to the agent access validation API 146, which provides the AUI p-token to the AUI API 144. The AUI API 144 may then provide the AUI p-token to the AUI 122 that has now been authorized to use the p-token.

The method 600, at B618 includes, based on the session record associated with the access session and the agent token, establishing an instance of the access session associated with the session ID to transact, via a network, with at least one user data profile from the system of records. For a given principal ID, the agent session database 124 may store data for one or more distinct session IDs – for example where a first AUI hosted on UE 120 is accessing data from the system of records 130 within a first access session, and a second AUI hosted on UE 120 is accessing data from the system of records 130 within a second access session. Any of the AUIs hosted on a UE 120 may obtain the session data for any of the sessions established for that AUI (which may be associated with any one of one or more distinct principal IDs) based on referencing a corresponding session ID record in the agent session database 124.

To initiate access to a user data profile 132, the AUI 122 may issue a data request API call to the AUI API 144. The data request API call may include the a-token, the AUI p-token, and the principal ID. The AUI API 144 may validate the a-token and the AUI p-token. In some embodiments, validation may include the AUI API 144 performing one or more additional authorizations based on logic and/or rules applicable to a particular AUI 122. In some embodiments, the AUI p-token may be validated through a call to the principal IDP 147. The system of records 130 may transmit the authorized principal data to the AUI API 144, which in turn transmits the authorized principal data to the AUI API 144 authorized to receive that data. The agent may then control and/or interface with AUI 122 (e.g., via a display screen of the UE 120) to perform one or more operations based on the authorized principal data, such as to display, modify and/or otherwise perform transactions with and/or based on the user data profile 132.

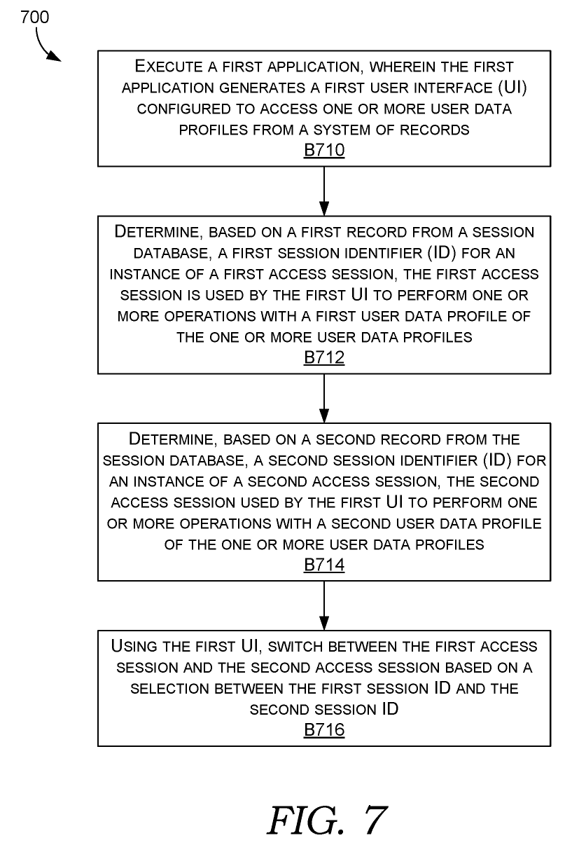

FIG. 7 is a flow chart illustrating a method 700 for multi-session agent authentication for accessing data records, according to some embodiments. It should be understood that the features and elements described herein with respect to the method of FIG. 7 may be used in conjunction with, in combination with, or substituted for elements of any of the other embodiments discussed herein and vice versa. Further, it should be understood that the functions, structures, and other descriptions of elements for embodiments described in FIG. 7 may apply to like or similarly named or described elements across any of the figures and/or embodiments described herein and vice versa.

In some embodiments, elements of method 700 are implemented utilizing one or more processing units, such as the controller of an operator core network, a network node, a networked server, an edge server, a RAN, user equipment (UE), a computing device, a cloud computing environment, and/or other processing units or computing devices as disclosed in any of the embodiments herein. In some embodiments, elements of method 700 are implemented utilizing one or more processing units comprising processing circuitry, such as the controller of an operator core network, a network node, a networked server, an edge server, an access network, a RAN, user equipment (UE), a computing device, a cloud computing environment, and/or other processing units or computing devices as disclosed in any of the embodiments herein. In some embodiments, the method 700 may be implemented by components of a telecommunications network environment 500, such as illustrated by FIG. 5.

The method 700, at B710, includes executing a first application, wherein the first application generates a first user interface (UI) configured to access one or more user data profiles from a system of records. As explained herein, an agent user of a UE 120 may use one or more of the AUIs 122 to issue API calls to obtain access to the user data profiles 132. AUIs 122 may include applications hosted on a UE (e.g., a website browser or a native client application) that may be used to access information from a network server.

The method 700, at B712, includes determining, based on a first record from a session database, a first session identifier (ID) for an instance of a first access session, the first access session used by the first user interface (UI) to perform one or more operations with a first user data profile of the one or more user data profiles. The method 700, at B714, includes determining, based on a second record from the session database, a second session identifier (ID) for an instance of a second access session, the second access session used by the first UI to perform one or more operations with a second user data profile of the one or more user data profiles. For a given principal ID, the agent session database 124 may store data for one or more distinct session IDs – for example where a first AUI hosted on UE 120 is accessing data from the system of records 130 within a first access session, and a second AUI hosted on UE 120 is accessing data from the system of records 130 within a second access session. Any of the AUI hosted on a UE 120 may obtain the session data for any of the sessions established for that AUI (which may be associated with any one of one or more distinct principal IDs) based on referencing a corresponding session ID record in the agent session database 124. To initiate access to a user data profile 132, the AUI 122 may issue a data request API call to the AUI API 144. The data request API call may include the a-token, the AUI p-token, and the principal ID. The AUI API 144 may validate the a-token and the AUI p-token. In some embodiments, validation may include the AUI API 144 performing one or more additional authorizations based on logic and/or rules applicable to a particular AUI 122. In some embodiments, the AUI p-token may be validated through a call to the principal IDP 147. The system of records 130 may transmit the authorized principal data to the AUI API 144, which in turn transmits the authorized principal data to the AUI API 144 authorized to receive that data. The agent may then control and/or interface with AUI 122 (e.g., via a display screen of the UE 120) to perform one or more operations based on the authorized principal data, such as to display, modify, and/or otherwise perform transactions with and/or based on the user data profile 132.

The method 700, at B716, includes using the first UI, switching between the first access session and the second access session based on a selection between the first session ID and the second session ID. As discussed herein, when an AUI 122 is accessing a first user data profile 132 for one principal ID (to assist a first principal user) and needs to switch over to a second user data profile 132 for another principal ID (to assist a second principal user), the AUI 122 may reference the agent session database 124 to confirm whether the AUI p-token for the second principal user is valid or stale before making API calls to access the second user data profile 132. The token exchange and session-based mechanisms described herein permit the agent to dynamically switch between sessions to access different user data profiles (for different principal users), without having to re-obtain credentials each time they switch between sessions. Having session data stored in the agent session database 124 (rather than as cookies) permits an AUI 122 to readily switch between previously established access sessions with the system of records 130 by obtaining the pertinent session ID and/or tokens directly from the agent session database 124 and using that information to continue performing transactions with the system of records 130. Moreover, as described below with respect to FIG. 3, the session data for an active access session may be used by an AUI 122 to request the principal IDP 147 to provide credentials for an extended session (e.g., to refresh a session) based on a session ID without having to re-authenticate the agent or re-validate the principal ID. Furthermore, for a given principal ID, the agent session database 124 may store data for one or more distinct session IDs – for example where a first AUI hosted on UE 120 is accessing data from the system of records 130 within a first access session, and a second AUI hosted on UE 120 is accessing data from the system of records 130 within a second access session. Any of the AUI hosted on a UE 120 may obtain the session data for any of the sessions established for that AUI (which may be associated with any one of one or more distinct principal IDs) based on referencing a corresponding session ID record in the agent session database 124.

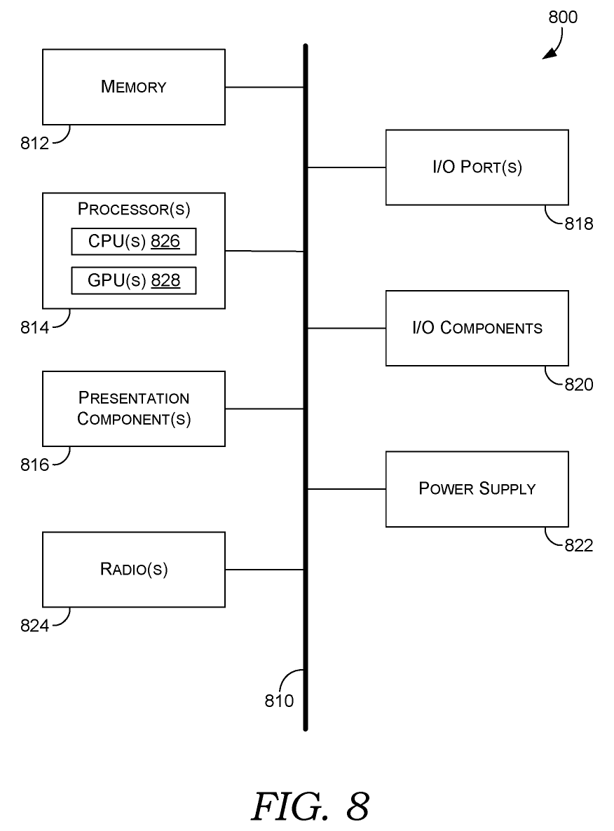

Referring to FIG. 8, a diagram is depicted of an exemplary computing environment suitable for use in implementations of the present disclosure. In particular, the exemplary computer environment is shown and designated generally as computing device 800. Computing device 800 is but one example of a suitable computing environment and is not intended to suggest any limitation as to the scope of use or functionality of the embodiments described herein, and nor should computing device 800 be interpreted as having any dependency or requirement relating to any one or combination of components illustrated. In various embodiments, one or more aspects of a UE 110, UE 120, agent user interface 122, agent session database 124, and/or API-based validation framework 140 may be implemented at least in part using a computing device 800.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 8, computing device 800 includes bus 810 that directly or indirectly couples the following devices: memory 812, one or more processors 814, one or more presentation components 816, input/output (I/O) ports 818, I/O components 820, power supply 822, and radio 824. Bus 810 represents what may be one or more buses (such as an address bus, data bus, or combination thereof). The devices of FIG. 8 are shown with lines for the sake of clarity. However, it should be understood that the functions performed by one or more components of the computing device 800 may be combined or distributed amongst the various components. For example, a presentation component such as a display device may be one of I/O components 820. In some embodiments, one or more functions of an agent user interface 122, agent session database 124, and/or API-based validation framework 140 may be executed at least in part by computing device 800. The processors 814 of computing device 800 may include a memory. The present disclosure hereof recognizes that such is the nature of the art, and reiterates that FIG. 8 is merely illustrative of an exemplary computing environment that can be used in connection with one or more implementations of the present disclosure. Distinction is not made between such categories as “workstation,” “server,” “laptop,” “handheld device,” “smart television,” etc., as all are contemplated within the scope of FIG. 8 and refer to “computer” or “computing device.”

Computing device 800 typically includes a variety of computer-readable media storing computer-usable instructions. For example, applications, algorithms, and/or neural networks may be stored in a memory comprising such computer-readable media. Computer-readable media can be any available media that can be accessed by computing device 800 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data.

Computer storage media includes non-transient random-access memory (RAM), read-only memory (ROM), electrically erasable programmable read-only memory (EEPROM), flash memory or other memory technology, compact disk (CD)-ROM, digital versatile disks (DVDs) or other optical disk storage, magnetic cassettes, magnetic tape, magnetic disk storage, or other magnetic storage devices. Computer storage media and computer-readable media do not comprise a propagated data signal or signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer-readable media.

Memory 812 includes computer storage media in the form of volatile and/or non-volatile memory. Memory 812 may be removable, non-removable, or a combination thereof. Exemplary memory includes solid-state memory, hard drives, optical-disc drives, etc. Computing device 800 includes one or more processors 814 that comprise processing circuitry and that read data from various entities such as bus 810, memory 812, and/or I/O components 820. Processors 814 may include one or more central processing units (CPUs) 826 and/or one or more graphics processing units (GPUs) 828. In some embodiments, one or more functions of the agent user interface 122, agent session database 124, and/or API-based validation framework 140 described herein may include software code executed on CPUs 826 and/or GPUs 828. One or more presentation components 816 present data indications to a person or other device. Exemplary one or more presentation components 816 include a display device, speaker, printing component, vibrating component, etc. I/O ports 818 allow computing device 800 to be logically coupled to other devices including I/O components 820, some of which may be built into computing device 800. Illustrative I/O components 820 include a microphone, joystick, game pad, satellite dish, scanner, printer, wireless device, etc. In some embodiments, the I/O components 820 may include a network interface card (NIC) for coupling to a network, such as described herein.

Radio(s) 824 represents a radio that facilitates communication with a wireless telecommunications network (such as telecommunications network 500). For example, radio(s) 824 may be used to establish communications with components of a network 105, access network 502, operator core network 510, and/or core network edge 511. Illustrative wireless telecommunications technologies include code-division multiple access (CDMA), general packet radio service (GPRS), time-division multiple access (TDMA), global system for mobile communications (GSM), and the like. Radio(s) 824 may additionally or alternatively facilitate other types of wireless communications including Wi-Fi, WiMAX, LTE, and/or other voice-over-internet protocol (VoIP) communications. In some embodiments, radio(s) 824 may support multimodal connections that include a combination of 3GPP radio technologies (e.g., 4G, 5G, and/or 6G) and/or non-3GPP radio technologies. As can be appreciated, in various embodiments, radio(s) 824 can be configured to support multiple technologies, and/or multiple radios can be utilized to support multiple technologies. In some embodiments, the radio(s) 824 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

Referring to FIG. 9, a diagram is depicted generally at 900 of an exemplary cloud computing environment 910 for implementing one or more aspects of multi-session agent authentication for accessing data records, as implemented by the systems and methods described herein. Cloud computing environment 910 is but one example of a suitable cloud computing environment and is not intended to suggest any limitation as to the scope of use or functionality of the embodiments presented herein, and nor should cloud computing environment 910 be interpreted as having any dependency or requirement relating to any one or combination of components illustrated. In some embodiments, the cloud computing environment 910 is coupled to a network 900 (e.g., network 105) and/or may be executed within operator core network 510, the core network edge 511, edge server 530, or otherwise coupled to the core network edge 511 or operator core network 510.

Cloud computing environment 910 includes one or more controllers 920 comprising one or more processors and memory. The controllers 920 may comprise servers of a data center. In some embodiments, the controllers 920 are programmed to execute code to implement at least one or more aspects of an API-based validation framework 140, system of records 130 and/or agent session database 124 as described herein. For example, in one embodiment a network function for a validation framework 140 as discussed herein may be implemented as one or more virtual network functions (VNFs) 930 (which may include one or more container network functions (CNFs) running on a worker node cluster 925 established by the controllers 920.

The cluster of worker nodes 925 may include one or more orchestrated Kubernetes (K8s) pods that realize one or more containerized applications 935. In other embodiments, another orchestration system may be used. For example, the worker nodes 925 may use lightweight Kubernetes (K3s) pods, Docker Swarm instances, and/or other orchestration tools. In some embodiments, one or more elements of the environment 100 may be implemented by, or coupled to, the controllers 920 of the cloud computing environment 910 by network 105, operator core network 510, and/or core network edge 511. In some embodiments, one or more elements of a system of records 130 and/or agent session database 124 may be implemented at least in part using one or more data store persistent volumes 940 in the cloud computing environment 910.

In various alternative embodiments, system and/or device elements, method steps, or example implementations described throughout this disclosure (such as the UE, network nodes, servers, access networks, core network edge, operator core network, network functions, validation frameworks, and/or any of the sub-parts thereof, for example) may be implemented at least in part using one or more computer systems, field-programmable gate arrays (FPGAs), application-specific integrated circuits (ASICs), or similar devices comprising a processor coupled to a memory and executing code to realize the elements and/or processes, said code stored on a non-transient hardware data storage device. Therefore, other embodiments of the present disclosure may include elements comprising program instructions resident on computer-readable media that when implemented by such computer systems enable them to implement the embodiments described herein. As used herein, the term “computer-readable media” refers to tangible memory storage devices having non-transient physical forms. Such non-transient physical forms may include computer memory devices, such as but not limited to: punch cards, magnetic disk or tape, any optical data storage system, flash read-only memory (ROM), non-volatile ROM, programmable ROM (PROM), erasable-programmable ROM (E-PROM), random-access memory (RAM), or any other form of permanent, semi-permanent, or temporary memory storage system of a device having a physical, tangible form. Program instructions include, but are not limited to, computer-executable instructions executed by computer system processors and hardware description languages such as Verilog or Very High-Speed Integrated Circuit (VHSIC) Hardware Description Language (VHDL).

As used herein, the terms “network function,” “framework,” “processor,” “controller,” “unit,” “model,” “server,” “node,” and “module” are used to describe computer processing components and/or one or more computer-executable services being executed on one or more computer processing components. In the context of this disclosure, such terms used in this manner would be understood by one skilled in the art to refer to specific network elements and are not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for multi-session agent authentication, the system comprising:
one or more processors; and
one or more computer-readable media storing computer-usable instructions that when executed by the one or more processors cause the one or more processors to:
execute a first application, wherein the first application generates a first user interface (UI) configured to access one or more user data profiles from a system of records;
obtain an agent token associated with an agent user of the system;
request a principal token from a validation framework, the principal token associated with a principal identity (ID) of a principal user and further associated with the first UI;
receive the principal token and a session ID associated with an access session between the first UI and the system of records, and store at least the session ID, the principal ID, and the principal token to an agent session database comprising a session record associated with the access session; and
based on the session record associated with the access session and the agent token, establish an instance of the access session associated with the session ID to transact, via a network, with at least one user data profile from the system of records.

2. The system of claim 1, wherein the one or more processors are further to:
receive the principal ID via the network from a user equipment associated with the principal user.

3. The system of claim 1, wherein the one or more processors are further to:
display, via the first UI, authorized principal data based on the at least one user data profile accessed from the system of records.

4. The system of claim 1, wherein the one or more processors are further to:
obtain the agent token based on completing an authentication challenge with an identity provider.

5. The system of claim 1, wherein the one or more processors are further to:
send a request for the principal token from the first application to an application programming interface of the validation framework, wherein the request includes at least the principal ID, the agent token, and an OAuth credential, and wherein the application programming interface of the validation framework returns the session ID and a code for generating the principal token to the first application; and
send the code for generating the principal token and a secret from the first application to the application programming interface of the validation framework, wherein the application programming interface of the validation framework returns the principal token to the first application.

6. The system of claim 1, wherein the one or more processors are further to:
determine when the principal token as stored in the agent session database is valid or stale based on an indication of lifetime;
execute one or more transactions with the at least one user data profile using the access session associated with the session ID to transact in response to determining that the principal token as stored in the agent session database is valid; and
send a request for a session extension to the validation framework to obtain a new principal token from the validation framework in response to determining that the principal token as stored in the agent session database is stale.

7. The system of claim 6, wherein the request for a session extension comprises at least the agent token and the session ID as indicated by the request for a session extension associated with the access session; and
wherein the one or more processors are further to:
receive the new principal token and a new session ID associated with the access session, and store at least the new session ID and the new principal token to the session record associated with the access session.

8. The system of claim 1, wherein the one or more processors are further to initiate a handover from the first application to a second application, wherein the second application generates a second UI configured to access the one or more user data profiles from the system of records; and
wherein the first application sends a session handover request to the validation framework to initiate generation of a new session ID and a new principal token, wherein the new session ID and the new principal token are associated with the second application.

9. The system of claim 1, wherein the one or more processors are further to:
determine, based on a first record from a session database, a first session identifier (ID) for an instance of a first access session, the first access session used by the first UI to perform one or more operations with a first user data profile of the one or more user data profiles;
determine, based on a second record from the session database, a second session identifier (ID) for an instance of a second access session, the second access session used by the first UI to perform one or more operations with a second user data profile of the one or more user data profiles; and
using the first UI, switch between the first access session and the second access session based on a selection between the first session ID and the second session ID.

10. A telecommunications network, the network comprising:
an operator core network;
at least one edge server of the operator core network coupled to a core network edge of the operator core network;
at least one access network coupled to the operator core network, wherein the at least one access network establishes one or more communication links between the operator core network and one or more user equipment (UE); and
at least one network function for a validation framework executed on one or more processors of the at least one edge server, wherein a first UE of the one or more UE is configured to:
execute a first application, wherein the first application generates a first user interface (UI) configured to access one or more user data profiles from a system of records hosted on a server of a data network coupled to the operator core network;
obtain an agent token associated with an agent user of the first application;
request a principal token from the validation framework, the principal token associated with a principal identity (ID) of a principal user;
receive from the validation framework the principal token and a session ID associated with an access session between the first UI and the system of records, and store at least the session ID, the principal ID, and the principal token to an agent session database comprising a session record associated with the access session; and
based on the session record associated with the access session and the agent token, establish an instance of the access session associated with the session ID to transact, via the at least one access network, with at least one user data profile from the system of records.

11. The network of claim 10, wherein the first UE receives the principal ID via the at least one access network from a second UE associated with the principal user.

12. The network of claim 10, wherein the first UE is further configured to:
send a request for the principal token from the first application to an application programming interface of the validation framework, wherein the request includes at least the principal ID, the agent token, and an Oauth credential, and wherein the application programming interface of the validation framework returns the session ID and a code for generating the principal token to the first application; and
send the code for generating the principal token and a secret from the first application to the application programming interface of the validation framework, wherein the application programming interface of the validation framework returns the principal token to the first application.

13. The network of claim 10, wherein the first UE is further configured to:
determine when the principal token as stored in the agent session database is valid or stale based on an indication of lifetime; and
execute one or more transactions with the at least one user data profile using the access session associated with the session ID to transact in response to determining that the principal token as stored in the agent session database is valid; and
send a request for a session extension to the validation framework to obtain a new principal token from the validation framework in response to determining that the principal token as stored in the agent session database is stale.

14. The network of claim 13, wherein the request for a session extension comprises at least the agent token and the session ID as indicated by the session record associated with the access session; and
wherein the first UE is further configured to:
receive the new principal token and a new session ID associated with the access session, and store at least the new session ID and the new principal token to the session record associated with the access session.

15. The network of claim 10, wherein the validation framework comprises:
an agent identity provider configured to generate the agent token associated with the agent user of the first application.

16. The network of claim 10, wherein the validation framework comprises:
a first application programming interface configured to communicate with the first application;
a second application programming interface configured to validate the agent token; and
a principal identity provider configured to generate the principal token.

17. The network of claim 10, wherein the validation framework comprises:
a principal identity provider configured to generate a new session ID for the access session in response to the validation framework receiving an access session extension request or a session handover request.

18. A system for multi-session agent authentication, the system comprising:
one or more processors; and
one or more computer-readable media storing computer-usable instructions that when executed by the one or more processors cause the one or more processors to:
execute a first application, wherein the first application generates a first user interface (UI) configured to access one or more user data profiles from a system of records;
determine, based on a first record from a session database, a first session identifier (ID) for an instance of a first access session, the first access session used by the first UI to perform one or more operations with a first user data profile of the one or more user data profiles;
determine, based on a second record from the session database, a second session identifier (ID) for an instance of a second access session, the second access session used by the first UI to perform one or more operations with a second user data profile of the one or more user data profiles; and
using the first UI, switch between the first access session and the second access session based on a selection between the first session ID and the second session ID.

19. The system of claim 18, wherein the one or more processors are further to:
determine when a principal token associated with either the first access session or the second access session as stored in the session database is valid or stale based on an indication of lifetime; and
send a request, comprising the first session ID or the second session ID, for a session extension to an application programming interface of a validation framework to obtain a new principal token from the validation framework in response to determining that the principal token as stored in the session database is stale.

20. The system of claim 18, wherein the one or more processors are further to:
initiate a handover from the first application to a second application, wherein the second application generates a second UI configured to access the one or more user data profiles from the system of records; and
wherein the first application sends a session handover request to an application programming interface of a validation framework to initiate generation of a new session ID and a new principal token, wherein the new session ID and the new principal token are associated with the second application.
